(19) United States
(12) Patent Application Publication
(10) Pub. No.: US 2023/0323834 A1
(43) Pub. Date: Oct. 12, 2023

(54) GAS TURBINE ENGINE WITH A COMPRESSED AIRFLOW INJECTION ASSEMBLY

(71) Applicant: General Electric Company, Schenectady, NY (US)

(72) Inventors: Ravish Karve, Bengaluru (IN); Vishnu Vardhan Venkata Tatiparthi, Bengaluru (IN); Trevor Howard Wood, Clifton Park, NY (US)

(21) Appl. No.: 17/841,868

(22) Filed: Jun. 16, 2022

(30) Foreign Application Priority Data
Apr. 8, 2022 (IN) 202211021214

(51) Int. Cl. F02K 3/00; F02C 7/04

(52) U.S. Cl. CPC F02K 3/00; F02C 7/04

(57) ABSTRACT

A gas turbine engine defining an axial direction and a radial direction, the gas turbine engine including: a turbomachine; a fan rotatable by the turbomachine, the fan including a plurality of fan blades; a plurality of outlet guide vanes located downstream of the plurality of fan blades of the fan; a casing surrounding the plurality of fan blades or surrounding at least in part the turbomachine, the casing defining an opening at a location upstream of the plurality of outlet guide vanes; and a compressed airflow injection assembly positioned at least partially within the casing and configured to provide a flow of compressed airflow through the opening in a repeating pattern during an operating condition of the gas turbine engine.

### PRIORITY INFORMATION

The present application claims priority to Indian Provisional Patent Application Number 202211021214 filed on Apr. 8, 2022.

### FIELD

The present subject matter relates generally to a gas turbine engine, and in particular to a gas turbine engine having a compressed airflow injection assembly.

### BACKGROUND

A gas turbine engine generally includes a turbomachine and a rotor assembly. Gas turbine engines, such as turbofan engines, may be used for aircraft propulsion. In the case of a turbofan engine, the rotor assembly may be configured as a fan assembly and an outer nacelle may be provided to surround the fan assembly.

During operation, interaction between the fan and engine components can cause acoustics during relative rotational passing of the fan to the engine components.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of an exemplary gas turbine engine according to various embodiments of the present subject matter.

FIG. 2 is a close-up, cross-sectional view of a fan section and a forward end of a turbomachine of the exemplary gas turbine engine of FIG. 1.

FIG. 3 is a close-up, schematic view of a fan blade and an outlet guide vane of the exemplary gas turbine engine of FIG. 2.

FIG. 4 is an axial view of a section of the portion of the exemplary gas turbine engine of FIG. 2, taken along Line 4-4.

FIG. 5 is a graph depicting an exemplary pulse rate of an airflow injection by an exemplary compressed airflow injection assembly of the present disclosure relative to a fan passing frequency.

FIG. 6 is a close-up, cross-sectional view of a fan section and a forward end of a turbomachine of a gas turbine engine in accordance with another exemplary aspect of the present disclosure.

FIG. 7 is a close-up, cross-sectional view of a fan section and a forward end of a turbomachine of a gas turbine engine in accordance with yet another exemplary aspect of the present disclosure.

FIG. 8 is a close-up, cross-sectional view of a fan section and a forward end of a turbomachine of a gas turbine engine in accordance with still another exemplary aspect of the present disclosure.

FIG. 9 is an axial view of a section of a gas turbine engine in accordance with an exemplary embodiment of the present disclosure, in the perspective of Line 4-4 of FIG. 2.

FIG. 10 is an axial view of a section of a gas turbine engine in accordance with another exemplary embodiment of the present disclosure, in the perspective of Line 4-4 of FIG. 2.

FIG. 11 is a close-up, schematic view of a fan blade and an outlet guide vane of a gas turbine engine of the present disclosure including a compressed airflow injection assembly of the present disclosure.

FIG. 12 is a flow diagram of a method of operating a compressed airflow injection assembly for a gas turbine engine in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers only A, only B, only C, or any combination of A, B, and C.

The term “and/or” in the context of, e.g., “A and/or B” refers to only A, only B, or A and B.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “noise” refers to vibrations through a medium that create sounds.

The term “noise reduction” or “noise reduction” refers to removing noise from a signal to therefore reduce a decibel level of noise.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

The present disclosure generally relates to a gas turbine engine having a turbomachine, a fan rotatable by the turbomachine, a plurality of outlet guide vanes located downstream of a plurality of fan blades of the fan; and a casing surrounding the plurality of fan blades or surrounding at least in part the turbomachine. For example, in one exemplary aspect, the casing may be an outer nacelle surrounding the plurality of fan blades. The casing of the gas turbine engine defines an opening at a location upstream of the plurality of outlet guide vanes, and more particularly for an exemplary embodiment of the present disclosure, defines a plurality of openings at a location upstream of the plurality of outlet guide vanes and downstream of the plurality of fan blades. The gas turbine engine further includes a compressed airflow injection assembly positioned at least partially within the casing and configured to provide a flow of compressed airflow through the opening, or openings, in a repeating pattern during an operating condition of the gas turbine engine.

As will be appreciated, the fan may generate vortical structures (e.g., airflow generally forming a vortex), and more specifically a tip of each of the respective fan blades may generate the vortical structures. The vortical structures may generate undesirable noise when they impinge upon the outlet guide vanes in a concentrated location.

In at least certain exemplary aspects, the compressed airflow injection assembly is more specifically configured to provide the flow of compressed airflow through the openings at a pulse rate equal to a fan passing frequency of the fan blades during the operating condition, and out of phase with the fan passing frequency. In such a manner, the compressed airflow injection assembly may be configured to interact with the vortical structures upstream of the outlet guide vanes to push at least a portion of the vortical structures inwardly along a radial direction of the gas turbine engine, distributing an interaction with a downstream outlet guide vane. Further, in at least certain exemplary embodiments, the outlet guide vanes may define an angle relative to a cross-sectional plane of the gas turbine engine, distributing a timing of such an interaction.

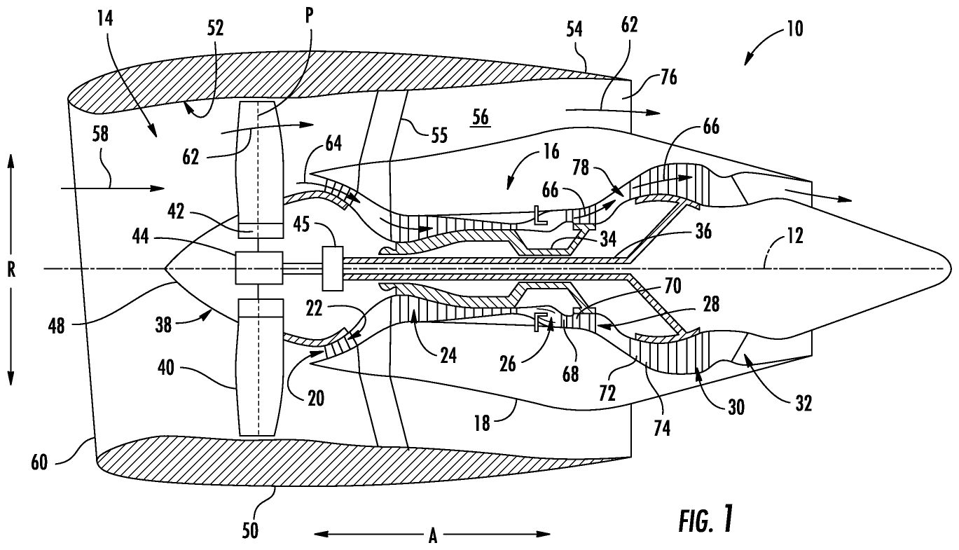

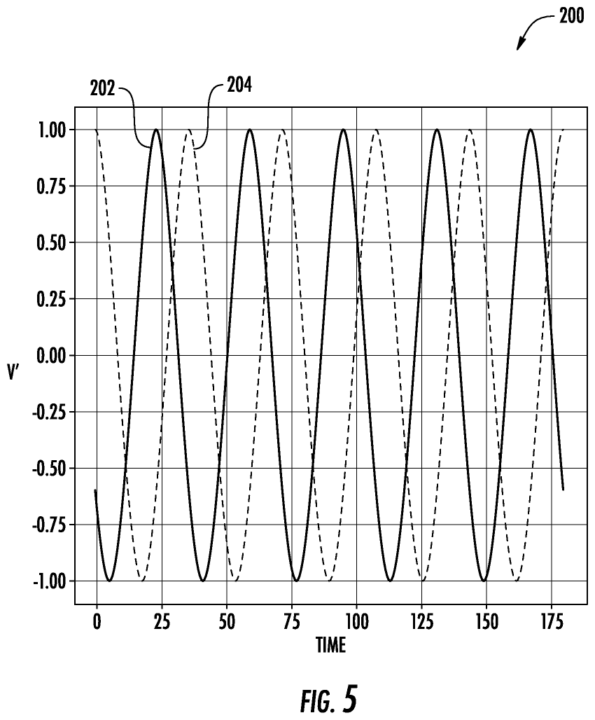

Referring now to the drawings, wherein identical numerals indicate the same or similar elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference), a radial direction R, and a circumferential direction (i.e., a direction extending about the axial direction A; see, e.g., FIG. 4). In general, the turbofan 10 includes a fan section 14 and a turbomachine 16 disposed downstream from the fan section 14.

The exemplary turbomachine 16 depicted generally includes a substantially tubular outer casing 18 that defines an annular inlet 20. The core casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. The LP turbine 30 may also be referred to as a “drive turbine”.

For the embodiment depicted, the fan section 14 includes a variable pitch fan 38 having a plurality of fan blades 40 coupled to a disk 42 in a spaced apart manner. More specifically, for the embodiment depicted, the fan section 14 includes a single stage fan 38, housing a single stage of fan blades 40. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable actuation member 44 configured to collectively vary the pitch of the fan blades 40 in unison. The fan 38 is mechanically coupled to and rotatable with the LP turbine 30, or drive turbine. More specifically, the fan blades 40, disk 42, and actuation member 44 are together rotatable about the longitudinal axis 12 by LP shaft 36. More specifically, still, the turbofan engine 10 includes a reduction gearbox 45, with the fan 38 mechanically coupled to and rotatable with the LP turbine 30 across the reduction gearbox 45.

Further, it will be appreciated that the fan 38 defines a fan pressure ratio and the plurality of fan blades 40 define a blade passing frequency. As used herein, the “fan pressure ratio” refers to a ratio of a pressure immediately downstream of the plurality of fan blades 40 during operation of the fan 38 to a pressure immediately upstream of the plurality of fan blades 40 during the operation of the fan 38. Also as used herein, the “blade passing frequency” defined by the plurality of fan blades 40 refers to a frequency at which a fan blade 40 passes a fixed location along the circumferential direction C of the gas turbine engine 10. The blade passing frequency may generally be calculated by multiplying a rotational speed of the fan 38 (in revolutions per minute) by the number of fan blades 40 and dividing by 60 (60 seconds per 1 minute).

Referring still to the exemplary embodiment of FIG. 1, the disk 42 is covered by rotatable front hub 48 aerodynamically contoured to promote an airflow through the plurality of fan blades 40. Additionally, the exemplary fan section 14 includes an annular fan casing or outer nacelle 50 that circumferentially surrounds the plurality of fan blades 40 of the fan 38, at least a portion of the turbomachine 16, or both. More specifically, the nacelle 50 includes an inner wall 52 and a downstream section 54 of the inner wall 52 of the nacelle 50 extends over an outer portion of the turbomachine 16 so as to define a bypass airflow passage 56 therebetween. Additionally, for the embodiment depicted, the nacelle 50 is partly supported relative to the turbomachine 16 by a plurality of circumferentially spaced outlet guide vanes 55.

During an operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the turbomachine 16 to provide propulsive thrust.

Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary turbofan engine 10 depicted in FIG. 1 and described above is by way of example only, and that in other exemplary embodiments, the turbofan engine 10 may have any other suitable configuration. For example, in other exemplary embodiments, the turbomachine 16 may include any other suitable number of compressors, turbines, and/or shaft or spools. Additionally, the turbofan engine 10 may not include each of the features described herein, or alternatively, may include one or more features not described herein. For example, in other exemplary embodiments, the fan 38 may not be a variable pitch fan, and the turbofan engine 10 may be a direct drive turbofan engine (e.g., may not have the reduction gearbox 45 between the LP shaft 38 and the fan 38). Additionally, although described as a “turbofan” gas turbine engine, in other embodiments the gas turbine engine may instead be configured as any other suitable ducted gas turbine engine.

Referring now also to FIG. 2, a close-up, cross-sectional view of the fan section 14 and a forward end of the turbomachine 16 of the exemplary turbofan engine 10 of FIG. 1 is provided.

As previously discussed, the fan section 14 of the turbofan engine 10 generally includes the fan 38 having the plurality of fan blades 40 defining a blade passing frequency during an operating condition of the turbofan engine 10. In addition, the turbofan engine 10 includes the plurality of outlet guide vanes 55 located downstream of the plurality of fan blades 40 of the fan 38, extending at least partially through the bypass passage 56 of the turbofan engine 10. Moreover, the turbofan engine 10 includes a casing surrounding the plurality of fan blades 40 or surrounding at least in part the turbomachine 16. More particularly, for the embodiment shown, the casing is configured as the outer nacelle 50 of the turbofan engine 10.

Moreover, although not depicted in FIG. 1, as will further be appreciated from the exemplary embodiment of the turbofan engine 10 depicted in FIG. 2, the casing, or rather, the outer nacelle 50, defines an opening 100 at a location upstream of the plurality of outlet guide vanes 55. Further, the exemplary turbofan engine 10 depicted includes a compressed airflow injection assembly 102 positioned at least partially within the casing, or rather the outer nacelle 50 for the embodiment shown, and configured to provide a flow of compressed air 104 through the opening 100 defined by the outer nacelle 50 in a repeating pattern during the operating condition of the gas turbine engine. As will be appreciated from the description herein, the compressed airflow injection assembly 102 may be configured to reduce noise by destructively interfering or otherwise modifying the noise attributable to an airflow from the fan 38 impinging upon the outlet guide vanes 55, and more particularly for vortical structures for a tip of each of the respective fan blades 40 impinging upon the outlet guide vanes 55.

More specifically, as is depicted in FIG. 2, it will be appreciated that the compressed airflow injection assembly 102 generally includes an air tube 106 extending between an inlet 108 and an outlet 110. The outlet 110 is in airflow communication with the opening 100 and the inlet 108 is in airflow communication with a high-pressure air source. In the exemplary embodiment depicted, the high-pressure air source is a compressor of the compressor section of the turbomachine 16. More specifically, still, for the embodiment shown, the high-pressure air source is the low-pressure compressor 22, such that the air tube 106 of the compressed airflow injection assembly 102 is configured to receive the flow of compressed air 104 from a main gas flowpath 112 of the turbomachine 16 at a location downstream of the low-pressure compressor 22 and upstream of the high-pressure compressor 24.

It will be appreciated, however, that in other exemplary embodiments, the high-pressure air source may instead be any other suitable location within the compressor section, such as an inter-stage location of the low-pressure compressor 22, an inter-stage location of the high-pressure compressor 24, a location downstream the high-pressure compressor 24, a turbine section of the turbomachine 16, an exhaust section 32 of the turbomachine 16 (see FIG. 1), or any other source of pressurized air.

Referring still to FIG. 2, it will be appreciated that the compressed airflow injection assembly 102 further includes a valve 114 in airflow communication with the air tube 106 and configured to control a flow of compressed air 104 from the high-pressure air source through the outlet 110 of the air tube 106 and through the opening 100 defined by the outer nacelle 50.

Moreover, for the exemplary aspect of the turbofan engine 10 depicted, the compressed airflow injection assembly 102, or both further includes a controller 116. The controller 116 may be in operable communication with the valve 114 for controlling operation of the valve 114. Further, the controller 116 may be in operable communication with one or more data sources for receiving data indicative of the operating condition of the turbofan engine 10. For example, referring briefly specifically to FIG. 2, it will be appreciated that the turbofan engine 10 includes a sensor 118. The sensor 118 may be configured to receive data indicative of a rotational speed of the fan 38, such as a blade passing frequency of the plurality of fan blades 40 of the fan 38. In other exemplary aspects, the sensor 118 may be configured to sense any other suitable data indicative of a rotational speed of the fan 38, such as a rotational speed of one or more spools of the turbofan engine 10.

In one or more exemplary embodiments, the controller 116 depicted in FIG. 2 may be a stand-alone controller 116 for the compressed airflow injection assembly 102, or alternatively, may be integrated into one or more of a controller for the gas turbine engine with which the compressed airflow injection assembly 102 is integrated, a controller for an aircraft including the gas turbine engine with which the compressed airflow injection assembly 102 is integrated, etc.

Referring particularly to the operation of the controller 116, in at least certain embodiments, the controller 116 can include one or more computing device(s) 120. The computing device(s) 120 can include one or more processor(s) 120A and one or more memory device(s) 120B. The one or more processor(s) 120A can include any suitable processing device, such as a microprocessor, microcontroller, integrated circuit, logic device, and/or other suitable processing device. The one or more memory device(s) 120B can include one or more computer-readable media, including, but not limited to, non-transitory computer-readable media, RAM, ROM, hard drives, flash drives, and/or other memory devices.

The one or more memory device(s) 120B can store information accessible by the one or more processor(s) 120A, including computer-readable instructions 120C that can be executed by the one or more processor(s) 120A. The instructions 120C can be any set of instructions that when executed by the one or more processor(s) 120A, cause the one or more processor(s) 120A to perform operations. In some embodiments, the instructions 120C can be executed by the one or more processor(s) 120A to cause the one or more processor(s) 120A to perform operations, such as any of the operations and functions for which the controller 116 and/or the computing device(s) 120 are configured, the operations for operating a compressed airflow injection assembly 102 (e.g., method 400), as described herein, and/or any other operations or functions of the one or more computing device(s) 120. The instructions 120C can be software written in any suitable programming language or can be implemented in hardware. Additionally, and/or alternatively, the instructions 120C can be executed in logically and/or virtually separate threads on processor(s) 120A. The memory device(s) 120B can further store data 120D that can be accessed by the processor(s) 120A. For example, the data 120D can include data indicative of power flows, data indicative of engine/aircraft operating conditions, and/or any other data and/or information described herein.

The computing device(s) 120 can also include a network interface 120E used to communicate, for example, with the other components of the compressed airflow injection assembly 102, the gas turbine engine incorporating the compressed airflow injection assembly 102, the aircraft incorporating the gas turbine engine, etc. For example, in the embodiment depicted, the gas turbine engine and/or compressed airflow injection assembly 102 may include one or more sensors for sensing data indicative of one or more parameters of the gas turbine engine, the compressed airflow injection assembly 102, or both. The controller 116 of the compressed airflow injection assembly 102 may be operably coupled to the one or more sensors through, e.g., the network interface, such that the controller 116 may receive data indicative of various operating parameters sensed by the one or more sensors during operation. Further, for the embodiment shown the controller 116 is operably coupled to, e.g., the valve 114. In such a manner, the controller 116 may be configured to actuate the valve 114 in response to, e.g., the data sensed by the one or more sensors (e.g., sensor 118).

The network interface 120E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

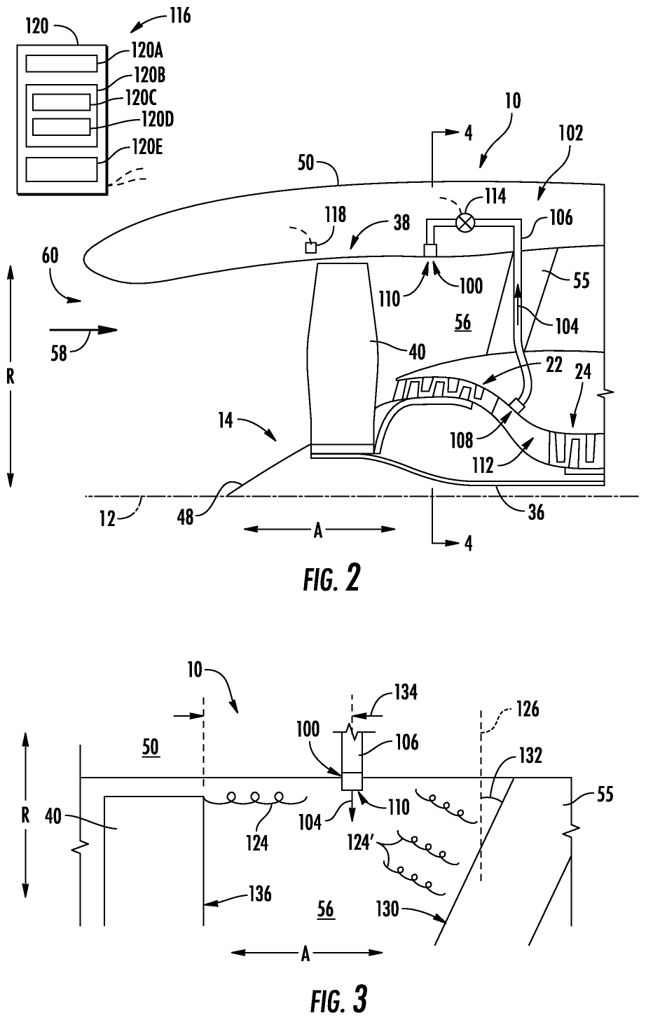

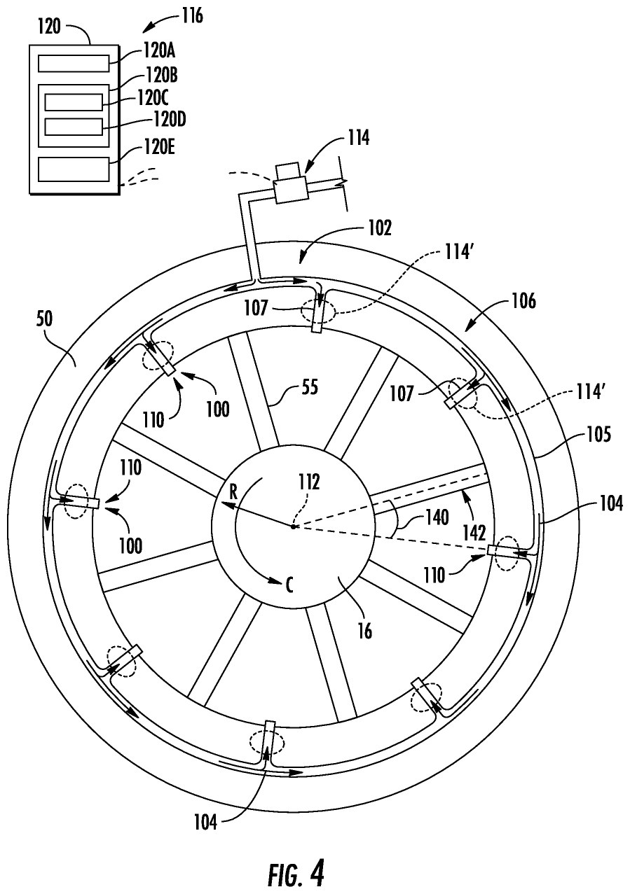

Referring now briefly to FIG. 3, a close-up view is provided of the fan blade 40 and outlet guide vane 55 of FIG. 2, along with the air tube 106 of the compressed airflow injection assembly 102 defining the outlet 110 and providing the compressed air 104. As will be appreciated, during the operating condition, the fan blade 40, or rather a tip 122 of the fan blade 40 may generate vortical structures 124. The vortical structures 124 may generate undesirable noise if they impinge upon the outlet guide vanes 55 in a concentrated location and in a simultaneous manner Distributing the vortical structures 124, e.g., along the radial direction R may therefore reduce such noise. In order to distribute the vortical structures 124 along the radial direction R of the engine, the compressed airflow injection assembly 102 provides the compressed air 104 which may push the vortical structures 124 inwardly along the radial direction R, creating more radially distributed vortical structures 124′. The more radially distributed vortical structures 124′ may impinge upon the outlet guide vane 55 in a more distributed manner, generating less noise, reducing noise compared with an undistributed manner, attenuating noise, suppressing noise, or the like.

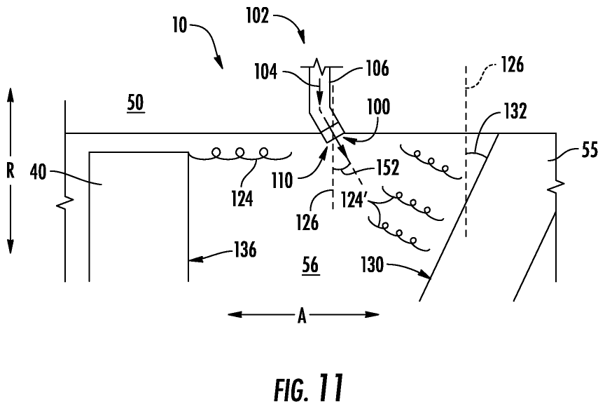

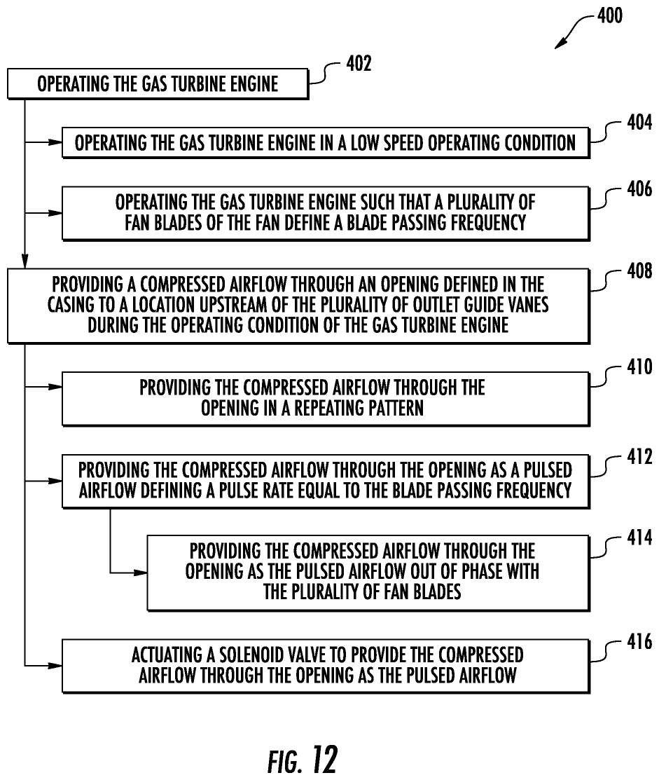

In such a manner, it will be appreciated that the outlet 110 of the air tube 106 may be configured to provide the compressed air 104 in a direction perpendicular to the radial direction R, such as within about 10 degrees (°) of the radial direction R, or within about 20° of the radial direction R, or within about 45° of the radial direction R, to effectively provide such functionality. Other embodiments are discussed below with reference to, e.g., FIG. 11.

Moreover, for the embodiment depicted, it will be appreciated that the outlet guide vanes 55 are slanted relative to a cross-sectional plane 126 of the turbofan engine 10. The cross-sectional plane 126 may be a plane defined in directions perpendicular to the longitudinal centerline 12 of the turbofan engine 10 (see FIG. 1). In particular, a leading edge 130 of the outlet guide vane 55 may define an angle 132 with the cross-sectional plane 126 greater than 0° and less than 60°, such as at least about 5°, such as at least about 10°, such as at least about 15°, such as up to about 45°, such as up to about 30°.

Referring still to FIG. 3, it will be appreciated that the outlet 110 defined by the outer nacelle 50 is located downstream of the plurality of fan blades 40. The outlet 110 can be further located upstream of the plurality of outlet guide vanes 55. In particular, the outlet 110 is, for the embodiment shown, located a first distance 134 from a trailing edge 136 of the fan blades 40 along the axial direction. A length of the first distance 134 may be utilized to control the compressed air 104 through the compressed airflow injection assembly 102. The first distance 134 may be equal to between about 5% and 95% of a total distance between the trailing edge 136 and leading edge 130 (where the leading edge 130 meets the outer nacelle 50). For example, the first distance may be between about 5% and about 75%, such as less than 60%, such as less than 50% (i.e., closer to the trailing edge 136 than the leading edge 130).

Referring now to FIG. 4, a cross-sectional view of the turbofan engine 10 of FIG. 2 is provided along Line 4-4 in FIG. 2. As will be appreciated, for the embodiment shown, the opening 100 defined by the casing, or rather by the outer nacelle 50, is a first opening 100 of a plurality of openings 100 defined by the outer nacelle 50. The plurality of openings 100 are spaced along the circumferential direction C of the turbofan engine 10. As is also depicted in FIG. 3, the plurality of outlet guide vanes 55 are also spaced along the circumferential direction C of the turbofan engine 10. The plurality of openings 100 defined by the outer nacelle 50 includes a number of openings 100 equal to N1. Similarly, the plurality of outlet guide vanes 55 includes a number of outlet guide vanes 55 equal to N2. In the embodiment shown, the number, N1, of the openings 100 in the plurality of openings 100 is equal to or greater than the number, N2, of outlet guide vanes 55 in the plurality of outlet guide vanes 55. More specifically, the number, N1, of the openings 100 in the plurality of openings 100 is a multiple of the number, N2, of outlet guide vanes 55 in the plurality of outlet guide vanes 55, and more specifically still, the number, N1, of the openings 100 in the plurality of openings 100 is equal to the number, N2, of outlet guide vanes 55 in the plurality of outlet guide vanes 55. In such a manner, the compressed airflow injection assembly 102 may provide for a noise reduction for the outlet guide vanes 55, as discussed in more detail below.

Moreover, as noted above, the outlet 110 of the air tube 106 is in airflow communication with the opening 100 defined by the outer nacelle 50 (i.e., airflow through the outlet 110 travels through the opening 100, either while still within the air tube 104 or after exiting the air tube 104). More specifically, for the embodiment depicted, the outlet 110 of the air tube 106 is a first outlet 110 of a plurality of outlets 110, with each outlet 110 in the plurality of outlets 110 in airflow communication with a respective opening 100 of the plurality of openings 100 defined by the outer nacelle 50.

In such a manner, it will be appreciated that in certain exemplary aspects, the compressed airflow injection assembly 102 may be configured to provide the compressed airflow through the opening 100, or rather the plurality of openings 100, as a pulsed airflow defining a pulse rate equal to the blade passing frequency defined by the plurality of fan blades 40 during the operating condition of the turbofan engine 10. More specifically, it will be appreciated that in only certain exemplary aspects, the compressed airflow injection assembly 102 may be configured to provide the compressed airflow through the opening 100, or rather the through the plurality of openings 100, as the pulsed airflow at the pulse rate equal to the blade passing frequency, but out of phase with the plurality of fan blades 40. As used herein, the term “out of phase” refers to having a different phase or stage of vibration or in a different phase or stage of vibration. With respect to being out of phase with the plurality of fan blades 40, such refers to being out of phase with the passing of the plurality of fan blades 40. Out of phase may refer to having a faster or slower period, but as noted above, in certain embodiments, the pulsed airflow may be provided at the pulse rate equal to the blade passing frequency.

Referring still to FIG. 4, it will be appreciated that the air tube 106 generally includes a manifold 105 extending in the circumferential direction C and a plurality of delivery tubes 107 extending from the manifold 105 to or through the openings 100 and defining the outlets 110. The delivery tubes 107 may extend to or through a single opening 100 for providing airflow 108 to or through the respective opening 100.

Also, as is depicted in phantom, in at least certain exemplary aspects, instead of a single valve 114, the compressed airflow injection assembly 102 may include a plurality of valves 114′, with each valve 114′ in airflow communication with a single delivery tube 107 of the plurality of delivery tubes 107. Each valve 114′ of the plurality of valves 114′ may be individually in operable communication with the controller 116, such that each valve 114′ of the plurality of valves 114′ may be individually controlled by the controller 116. In such a manner, the controller 116 may carefully control a pulsed timing and phasing between adjacent delivery tubes 107 and openings 100.

It should be appreciated that the phasing associated with wake interaction noise may be phased relative to the wakes arriving at the leading edges 130 of the outlet guide vanes 55 (see FIG. 3), so the phase difference will be different between adjacent delivery tubes 107 and openings 100. If the pulsed injection is for a direct acoustic wave generation out of phase with self-tone noise of the fan 38, then one or more multiples of the fan blade count may be provided and control the phasing in a uniform way may also be provided to provide a desired amount of destructive interference fan acoustic mode(s).

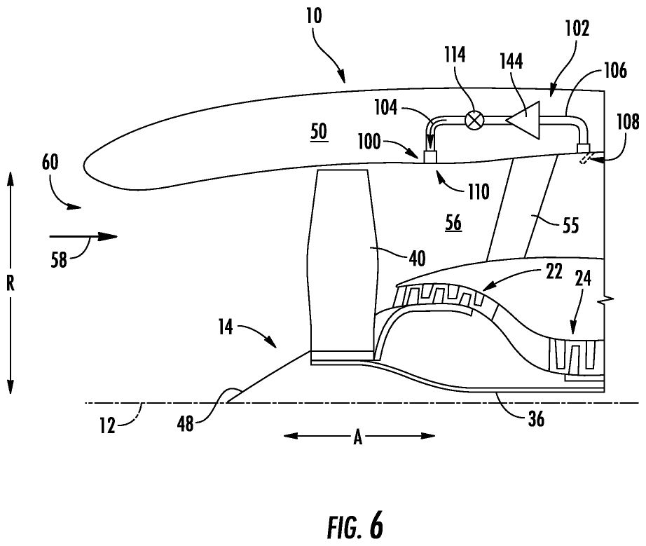

For example, referring briefly to FIG. 5, a graph 200 depicting such a configuration is provided. In particular, the exemplary graph 200 of FIG. 5 includes a first line 202 representing a blade passing frequency, wherein each peak represents a passing of a fan blade 40 relative to a circumferential reference point associated with an opening 100, and a second line 204 represents a pulsed injection of the compressed air 104 using the compressed airflow injection assembly 102, e.g., through the same opening 100. The second line 204 may represent a pressure of the airflow through the outlets 110 of the air tube 106 and through the openings 100 defined by the outer nacelle 50. As is shown, a frequency of the second line 204 is equal to a frequency of the first line 202, however the second line 204 is out of phase with the first line 202.

Notably, in order to provide for such a pulsed airflow, the valve 114 of the compressed airflow injection assembly 102 may be configured as a solenoid valve, and the controller 116 may be configured to control the solenoid valve using a pulse width modulation control, operate according to a duty cycle configured to provide the pulsed airflow at the frequency equal to the blade passing frequency, but out of phase with the blade passing.

It will be appreciated, however, that in other exemplary aspects, the valve 114 may refer to any other suitable mechanisms for providing pulsed airflow. For example, in other exemplary embodiments, the valve 114 may additionally or alternatively include one or more passive bistable fluidic oscillators that do not require an active switching. Further, in still other exemplary embodiments, the compressed airflow injection assembly 102 may use a synthetic jet, such as dual bimorph synthetic jets that operate without a separate source of air. With such a configuration, electrically actuated piezo-electric membranes may vibrate a bellows action device to provide an unsteady periodic jet of air from the device without requiring, e.g., a bleed airflow from a compressor. These synthetic jet(s) may be referred to herein as a high pressure air source as they are configured to generate a pulsed jet of pressurized air.

Referring briefly back to FIGS. 3 and 4, and first particularly back to FIG. 4, it will be appreciated that each of the plurality of outlets 110 is offset along the circumferential direction C from a respective outlet guide vane 55 of the plurality of outlet guide vanes 55. In particular, for the embodiment shown, each outlet 110 defines an angular separation 140 from a pressure side 142 of a closest outlet guide vane 55 (in a direction opposite a direction of rotation of the fan 38) greater than 0° and less than about 15°, such as between about 1° and about 10°, such as between about 3° and about 8°. Moreover, as briefly mentioned above and depicted in FIG. 3, the outlets 110 are located the first distance 134 from the trailing edge 136 of the fan blade 40. The angular separation 140 and first distance 234 may determine how far out of phase the pulse rate of the compressed air 104 is from the blade passing frequency.

It will be appreciated that the exemplary embodiment described above with reference to FIGS. 1 through 4 is provided by way of example only, and that in other exemplary embodiments, the compressed airflow injection assembly 102 may have any other suitable configuration to provide one or more of the exemplary benefits described herein.

For example, referring briefly to FIG. 6, a close-up, cross-sectional view of a fan section 14 and a forward end of a turbomachine 16 of a turbofan engine 10 having a compressed airflow injection assembly 102 in accordance with another exemplary aspect of the present disclosure is provided. The exemplary fan section 14 and turbomachine 16 may be configured in substantially the same manner as the exemplary fan section 14 and turbomachine 16 described above with reference to FIGS. 1 through 5. Further, the compressed airflow injection assembly 102 of FIG. 6 may also be configured in a similar manner to the exemplary compressed air 104 injection assembly of FIGS. 1 through 5.

For example, the exemplary compressed airflow injection assembly 102 generally includes an air tube 106 extending between an inlet 108 and an outlet 110, with the inlet 108 in airflow communication with an airflow source and the outlet 110 in airflow communication with an opening 100 defined by the outer nacelle 50. However, for the exemplary embodiment of FIG. 6, the airflow source is a bypass passage 56 of the turbofan engine 10 at a location downstream of the plurality of outlet guide vanes 55. In such a manner, it will be appreciated that the airflow received from the airflow source may not be at a sufficient pressure to facilitate the above-described functions of the compressed airflow injection assembly 102. According, for the exemplary embodiment of FIG. 6, the compressed airflow injection assembly 102 further includes an airflow pump 144 in airflow communication with the air tube 106 for increasing a pressure of the airflow through the air tube 106 (to generate the compressed air 104). The airflow pump 144 may be any suitable pump for increasing a pressure of the airflow. For example, the airflow pump 144 may be a rotary pump. The airflow pump 144 may be driven by an electric machine (not shown), accessory gearbox of the turbofan engine 10 (not shown), or any other suitable power source.

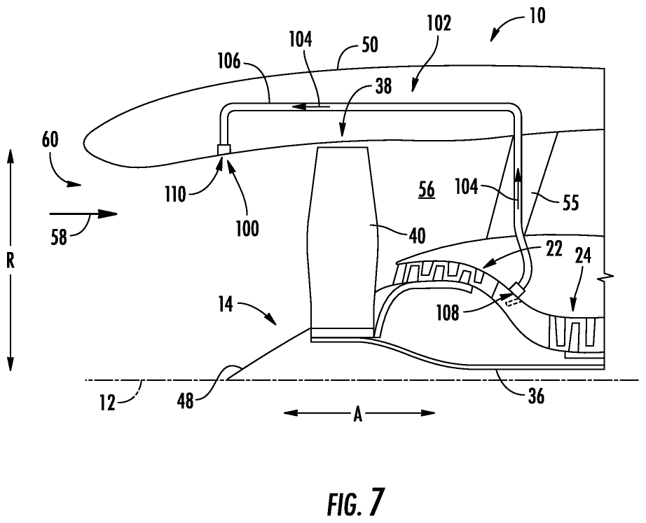

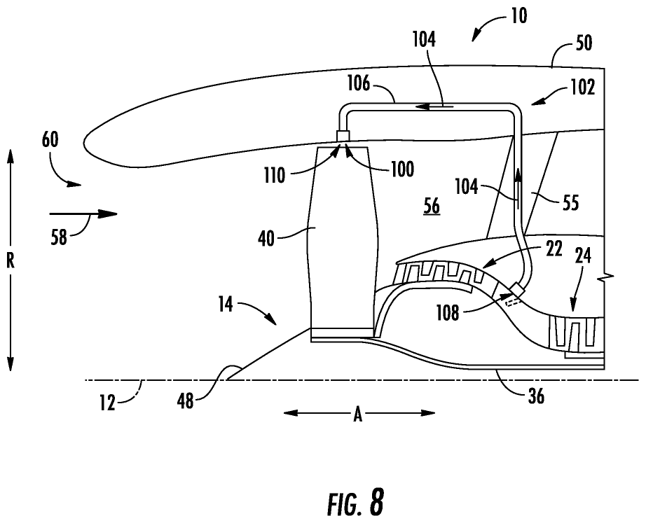

Further by way of example, referring briefly to FIG. 7, a close-up, cross-sectional view of a fan section 14 and a forward end of a turbomachine 16 of a turbofan engine 10 having a compressed airflow injection assembly 102 in accordance with yet another exemplary aspect of the present disclosure is provided. The exemplary fan section 14 and turbomachine 16 may be configured in substantially the same manner as the exemplary fan section 14 and turbomachine 16 described above with reference to FIGS. 1 through 5. Further, the compressed airflow injection assembly 102 of FIG. 7 may also be configured and a similar manner to the exemplary compressed air 104 injection assembly of FIGS. 1 through 5.

For example, the exemplary compressed airflow injection assembly 102 generally includes an air tube 106 extending between an inlet 108 and an outlet 110, with the inlet 108 in airflow communication with a high-pressure air source and the outlet 110 in airflow communication with an opening 100 defined by the outer nacelle 50. However, for the exemplary embodiment depicted, the outlet 110 defined by the outer nacelle 50 is located upstream of a plurality fan blades 40 of the fan 38. Notably, the air tube 106 and outlet 110 depicted in FIG. 7 may be configured in a similar manner as exemplary air tube 106 and plurality of outlets 110 described above with reference to FIG. 3, just located further upstream. It will be appreciated that by including the compressed airflow injection assembly 102 of FIG. 7, the compressed airflow injection assembly 102 may allow for improvement of a stall and/or flutter margin of the fan 38 at relatively low rotational speeds. In such a manner, the compressed airflow injection assembly 102 may improve operability of the turbofan engine 10, and more specifically of the fan 38.

In further exemplary aspects, other configurations may be provided. For example, in other exemplary embodiments, a gas turbine engine may be provided having a casing defining an opening 100, similar to the exemplary embodiments described above. However, in one or more of the other exemplary aspects, the casing may not be in outer nacelle 50, and instead may be an outer casing surrounding at least in part a turbomachine 16 of the gas turbine engine (e.g., outer casing 18 of turbofan engine 10 of FIG. 1). Providing the compressed air 104 at such a location may have a benefit of dispersing radially inward vortices downstream of the fan blades 40 of the fan 38, potentially improving noise reduction from the gas turbine engine.

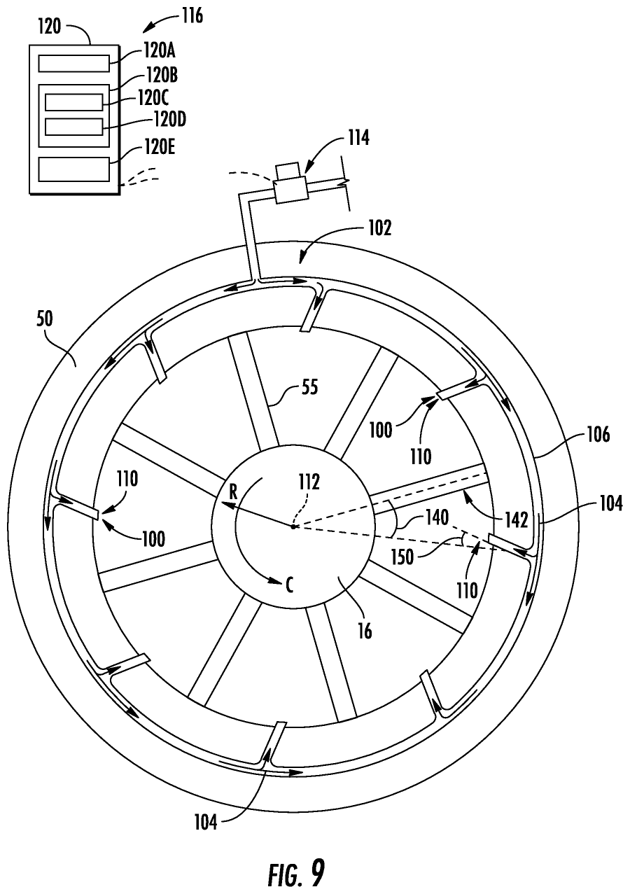

Further still by way of example, referring briefly to FIG. 8, a close-up, cross-sectional view of a fan section 14 and a forward end of a turbomachine 16 of a turbofan engine 10 having a compressed airflow injection assembly 102 in accordance with yet another exemplary aspect of the present disclosure is provided. The exemplary fan section 14 and turbomachine 16 may be configured in substantially the same manner as the exemplary fan section 14 and turbomachine 16 described above with reference to FIGS. 1 through 5. Further, the compressed airflow injection assembly 102 of FIG. 8 may also be configured and a similar manner to the exemplary compressed air 104 injection assembly of FIGS. 1 through 5.

For example, the exemplary compressed airflow injection assembly 102 generally includes an air tube 106 extending between an inlet 108 and an outlet 110, with the inlet 108 in airflow communication with a high-pressure air source and the outlet 110 in airflow communication with an opening 100 defined by the outer nacelle 50. However, for the exemplary embodiment depicted, the outlet 110 defined by the outer nacelle 50 is located outward of a plurality fan blades 40 of the fan 38 along a radial direction R of the gas turbine engine 10, and aligned along an axial direction A of the gas turbine engine 10. In such a manner, the outlet 110 overlaps with the plurality of fan blades 40. Notably, the air tube 106 and outlet 110 depicted in FIG. 8 may be configured in a similar manner as exemplary air tube 106 and plurality of outlets 110 described above with reference to FIG. 3, just located further upstream. It will be appreciated that by including the compressed airflow injection assembly 102 of FIG. 8, the compressed airflow injection assembly 102 may affect the airflow from the fan 38 more directly, potentially allowing for a desired noise suppression.

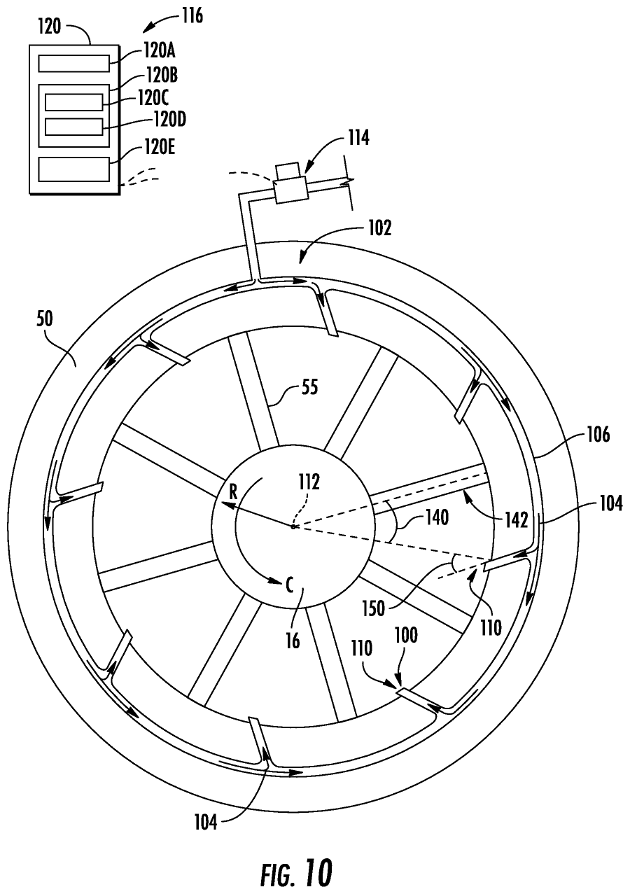

Referring now to FIGS. 9 through 11, views of gas turbine engines 10 having a compressed airflow injection assembly 102 in accordance with additional exemplary aspects of the present disclosure are provided.

Referring first particularly to FIG. 9, a cross-sectional view of a turbofan engine 10 is provided, in the same view as the embodiment of FIG. 4, described above. The exemplary turbofan engine 10 and compressed airflow injection assembly 102 of FIG. 9 may be configured in a similar manner as the exemplary turbofan engine 10 and compressed airflow injection assembly 102 of FIG. 4. However, it will be appreciated that for the exemplary embodiment of FIG. 9, the compressed airflow injection assembly 102 is configured to provide the flow of compressed airflow 104 through an opening 100 defined by a casing, or rather an outer nacelle 50, at an angle 150 greater than 0 degrees and less than 45 degrees in a circumferential direction C of the turbofan engine 10 and in a rotational direction of the plurality of fan blades 40. For the embodiment of FIG. 9, the plurality of fan blades 40 are configured to rotate in the direction of the arrow for the circumferential direction C depicted (counterclockwise).

By contrast, referring now to FIG. 10, a cross-sectional view of a turbofan engine 10 in accordance with another embodiment is provided, in the same view as the embodiment of FIG. 4, described above. The exemplary turbofan engine 10 and compressed airflow injection assembly 102 of FIG. 10 may be configured in a similar manner as the exemplary turbofan engine 10 and compressed airflow injection assembly 102 of FIG. 9. However, it will be appreciated that for the exemplary embodiment of FIG. 10, the compressed airflow injection assembly 102 is configured to provide the flow of compressed airflow 104 through an opening 100 defined by a casing, or rather an outer nacelle 50, at an angle 150 greater than 0° and less than 30° in a circumferential direction C of the gas turbine engine and against a rotational direction of the plurality of fan blades 40. For the embodiment of FIG. 10, the plurality of fan blades 40 are configured to rotate in the direction of the arrow for the circumferential direction C depicted (counterclockwise).

Further, referring now to FIG. 11, a close-up view is provided of a fan blade 40 and an outlet guide vane 55 of a turbofan engine 10 of the present disclosure, along with an air tube 106 of a compressed airflow injection assembly 102 defining an outlet 110 and providing a flow of compressed air 104 in accordance with an embodiment of the present disclosure. The embodiment of FIG. 11 may be configured in a similar manner as the embodiment of FIG. 3.

However, for the embodiment of FIG. 11, it will be appreciated that the turbofan engine 10 defines a cross-sectional plane 126 relative to the axial direction A, and that the compressed airflow injection assembly 102 is configured to provide the flow of compressed air 104 through the opening 100 at an angle 152 greater than 0° and less than 75° with the cross-sectional plane 126 of the turbofan engine 10.

It will be appreciated that with the embodiments of, e.g., FIGS. 9 through 11, the compressed airflow injection assembly 102 may be configured to provide an increase in acoustic reduction during operation of the turbofan engine 10 in a number of ways.

For example, in one exemplary aspect, the compressed airflow injection assembly 102 may be configured to provide an increase in acoustic reduction during operation of the turbofan engine 10 by filling in total pressure in vortical structures 124 from the plurality of fan blades 38 during operation of the gas turbine engine 10. The wakes in the vortical structures 124 may act as a fluctuating load on the outlet guide vanes 55, increasing a noise generated.

In order to fill in the wakes, the compressed airflow injection assembly 102 may be configured to provide the compressed airflow 104 at an angle 152 with the axial direction A (see FIG. 11) between 0° and 75° (0° shown in, e.g., FIG. 3). In particular, in certain exemplary embodiments to effective fill in the fan wakes 124, the angle 152 may be greater than 0° and less than about 75°, such as between about 10° and about 60°, such as between about 20° and about 45°. Further, in order to fill in the wakes, the compressed airflow injection assembly 102 may be configured to provide the compressed airflow 104 at an angle 150 in the circumferential direction C in the direction of rotation of the plurality of fan blades 38 (see FIG. 9) between 0° and 45° (0° shown in, e.g., FIG. 4). In particular, in certain exemplary embodiments to effective fill in the wakes 124, the angle 150 may be greater than 0° and less than about 45°, such as between about 5° and about 40°, such as between about 10° and about 35°.

In such a manner, the airflow 104 from the compressed airflow injection assembly 102 may be configured to approximately match a swirl of an airflow from the fan blades 38 and further may be configured to go with a momentum of the airflow from the fan blades 38, to effectively fill in wakes 124 from the plurality of fan blades 38 during operation of the gas turbine engine 10.

By contrast, in other exemplary aspects, it may be desirable to provide for an increased mixing of the vortical structures 124 from the fan blades 38 during operation of the gas turbine engine 10. With such an exemplary aspects, it may be desirable to provide the airflow 104 from the compressed airflow injection assembly 102 at an angle counter to a swirl angle of the airflow from the plurality of fan blades 38 during operation of the gas turbine engine 10. For example, with such a configuration, the compressed airflow injection assembly 102 may be configured to provide the compressed airflow 104 at an angle 150 in the circumferential direction C in the direction of rotation of the plurality of fan blades 38 (see FIG. 9) of 0° and up to about 45° or at an angle 150 in the circumferential direction C opposite the direction of rotation of the plurality of fan blades 38 (see FIG. 10) between 0° and about 45°. For example, in order to effectively provide for mixing of the vortical structures, the compressed airflow injection assembly 102 may be configured to provide the compressed airflow 104 at an angle 150 in the circumferential direction C opposite the direction of rotation of the plurality of fan blades 38 (see FIG. 10) greater than 0° and less than about 35°, such as between about 5° and about 30°. In certain exemplary aspects, the compressed airflow injection assembly 102 may be configured to provide the compressed airflow 104 at an angle 152 with the axial direction A of 0° (see, e.g., FIG. 3).

In such a manner, the airflow 104 from the compressed airflow injection assembly 102 may be configured to define a relative yaw angle with a swirl of an airflow from the fan blades 38 to provide for mixing of the vortical structures 124 from the fan blades 38 during operation of the gas turbine engine 10.

Referring now to FIG. 12, a flow diagram of a method 400 of operating a compressed airflow injection assembly for a gas turbine engine is provided. The method 400 may be utilized with one or more of the exemplary compressed airflow injection assemblies 102 described above with reference to FIGS. 1 through 11. Accordingly, it will be appreciated that the exemplary method 400 may be utilized with a gas turbine engine having a turbomachine, a fan, a plurality of outlet guide vanes, and a casing surrounding the plurality of fan blades or surrounding at least in part the turbomachine.

The exemplary method includes at (402) operating the gas turbine engine. More specifically, for the exemplary aspect depicted, operating the gas turbine engine (402) includes at (404) operating the gas turbine engine in a low speed operating condition. The low speed operating condition may refer to a rotational speed between about 25% percent and about 75% percent of a rated speed, such as a rotational speed of the gas turbine engine during a descent operating mode, a taxiing operating mode, a ground idle operating mode, or the like.

Further, it will be appreciated that for the exemplary aspect depicted, operating the gas turbine engine at (402) includes at (406) operating the gas turbine engine such that a plurality of fan blades and a rotational speed of the fan define a blade passing frequency.

Referring still to the exemplary aspect of FIG. 12, the method 400 further includes at (408) providing a compressed airflow through an opening defined in the casing to a location upstream of the plurality of outlet guide vanes during the operating condition of the gas turbine engine. For the aspect depicted, providing the compressed airflow through the opening at (408) further includes at (410) providing the compressed airflow through the opening in a repeating pattern.

The term “repeating pattern,” as it relates to the flow of compressed air through the opening, refers generally to a pressure, a volume, a speed, or a combination thereof of the airflow changing, with the change being repeated many times in sequence and the change being of the same quantity.

More specifically, as noted above, operating the gas turbine engine at (402) includes at (406) operating the gas turbine engine such that the plurality of fan blades of the fan define the blade passing frequency. With such exemplary aspect, providing the compressed airflow through the opening in the repeating pattern at (410) further includes at (412) providing the compressed airflow through the opening as a pulsed airflow defining a pulse rate equal to the blade passing frequency. Moreover, for the exemplary aspect depicted, providing the compressed airflow through the opening as the pulsed airflow at (412) further includes at (414) providing the compressed airflow through the opening as the pulsed airflow out of phase with the plurality of fan blades.

As discussed above, a valve, such as a solenoid valve, may be utilized to provide at least certain of the functionality of the method 400. For example, for the exemplary aspect depicted, providing the compressed airflow through the opening defined in the casing at (408) includes at (416) actuating a solenoid valve to provide the compressed airflow through the opening as the pulsed airflow.

Operation of a compressed airflow injection assembly in accordance with one or more exemplary aspects of the exemplary method 400 may allow for an increase in noise reduction attributable to airflow from a fan impinging upon a plurality of outlet guide vanes. In particular, operating a compressed airflow injection assembly in accordance with one or more exemplary aspects of the exemplary method 400 may allow for the compressed airflow provided to push vortical structures produced by the fan inwardly along a radial direction to inner portions of the plurality of outlet guide vanes, increasing an effective noise reduction of such an operation.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:
1. A gas turbine engine defining an axial direction and a radial direction, the gas turbine engine comprising: a turbomachine; a fan rotatable by the turbomachine, the fan comprising a plurality of fan blades; a plurality of outlet guide vanes located downstream of the plurality of fan blades of the fan; a casing surrounding the plurality of fan blades or surrounding at least in part the turbomachine, the casing defining an opening at a location upstream of the plurality of outlet guide vanes; and a compressed airflow injection assembly positioned at least partially within the casing and configured to provide a flow of compressed airflow through the opening in a repeating pattern during an operating condition of the gas turbine engine.
2. The gas turbine engine of one or more of these clauses, wherein the casing is an outer nacelle surrounding at least in part the plurality of fan blades.
3. The gas turbine engine of one or more of these clauses, wherein the opening in the casing is located downstream of the plurality of fan blades and upstream of the plurality of outlet guide vanes.
4. The gas turbine engine of one or more of these clauses, wherein when the gas turbine engine is operated in the operating condition, the plurality of fan blades define a blade passing frequency, and wherein the compressed airflow injection assembly is configured to provide the compressed airflow through the opening as a pulsed airflow defining a pulse rate equal to the blade passing frequency when the gas turbine engine is operated in the operating condition.
5. The gas turbine engine of one or more of these clauses, wherein the compressed airflow injection assembly is configured to provide the flow of compressed airflow through the opening as the pulsed airflow at the blade passing frequency out of phase with the plurality of fan blades.
6. The gas turbine engine of one or more of these clauses, wherein the compressed airflow injection assembly comprises an air tube extending between an inlet and an outlet, wherein the outlet is in airflow communication with the opening.
7. The gas turbine engine of one or more of these clauses, wherein the compressed airflow injection assembly further comprises a solenoid valve in airflow communication with the air tube configured to pulse the flow of compressed airflow through the air tube.
8. The gas turbine engine of one or more of these clauses, wherein the inlet of the air tube is in airflow communication with a high pressure air source.
9. The gas turbine engine of one or more of these clauses, wherein the turbomachine comprises a compressor section having a compressor, and wherein the high pressure air source is the compressor of the compressor section of the turbomachine
10. The gas turbine engine of one or more of these clauses, wherein the opening is a first opening of a plurality of openings defined by the casing, and wherein the plurality of openings are spaced along a circumferential direction of the gas turbine engine.
11. The gas turbine engine of one or more of these clauses, wherein the plurality of openings defined by the casing includes a number of openings equal to N1, wherein the plurality of outlet guide vanes includes a number of outlet guide vanes equal to N2, and wherein the number, N1, of the openings is equal to or greater than the number, N2, of outlet guide vanes.
12. The gas turbine engine of one or more of these clauses, wherein the gas turbine engine defines a cross-sectional plane relative to the axial direction, wherein the compressed airflow injection assembly is configured to provide the flow of compressed airflow through the opening at an angle greater than 0 degrees and less than 75 degrees with the cross-sectional plane of the gas turbine engine.
13. The gas turbine engine of one or more of these clauses, wherein the compressed airflow injection assembly is configured to provide the flow of compressed airflow through the opening at an angle greater than 0 degrees and less than 45 degrees in a circumferential direction of the gas turbine engine and in a rotational direction of the plurality of fan blades.
14. The gas turbine engine of one or more of these clauses, wherein the compressed airflow injection assembly is configured to provide the flow of compressed airflow through the opening at an angle greater than 0 degrees and less than 30 degrees in a circumferential direction of the gas turbine engine and against a rotational direction of the plurality of fan blades.
15. A method of operating a compressed airflow injection assembly for a gas turbine engine, the gas turbine engine comprising a turbomachine, a fan having a plurality of fan blades, a plurality of outlet guide vanes, and a casing surrounding the plurality of fan blades or enclosing at least in part the turbomachine, the method comprising: providing a compressed airflow through an opening defined in the casing to a location upstream of the plurality of outlet guide vanes, wherein providing the compressed airflow through the opening comprises providing the compressed airflow through the opening in a repeating pattern.
16. The method of one or more of these clauses, wherein the casing is an outer nacelle surrounding at least in part the plurality of fan blades.
17. The method of one or more of these clauses, wherein the opening in the casing is located downstream of the plurality of fan blades and upstream of the plurality of outlet guide vanes.
18. The method of one or more of these clauses, further comprising: operating the gas turbine engine such that the plurality of fan blades define a blade passing frequency; wherein providing the compressed airflow through the opening in the repeating pattern comprises providing the compressed airflow through the opening as a pulsed airflow defining a pulse rate equal to the blade passing frequency.
19. The method of one or more of these clauses, wherein providing the compressed airflow through the opening as the pulsed airflow defining the pulse rate equal to the blade passing frequency comprises providing the compressed airflow through the opening as the pulsed airflow out of phase with the plurality of fan blades.
20. The method of one or more of these clauses, wherein the compressed airflow injection assembly comprises an air tube extending between an inlet and an outlet, wherein the outlet is in airflow communication with the opening, and wherein the inlet of the air tube is in airflow communication with a high pressure air source.
21. A method of operating a compressed airflow injection assembly for a gas turbine engine, the gas turbine engine comprising a turbomachine, a fan having a plurality of fan blades, a plurality of outlet guide vanes, and a casing surrounding the plurality of fan blades or enclosing at least in part the turbomachine, the method comprising: providing a compressed airflow through an opening defined in the casing to a location upstream of the plurality of outlet guide vanes during an operating condition of the gas turbine engine, wherein providing the compressed airflow through the opening comprises providing the compressed airflow through the opening in a repeating pattern.
22. The gas turbine engine of one or more of these clauses, wherein

1. A gas turbine engine defining an axial direction and a radial direction, the gas turbine engine comprising:
a turbomachine;
a fan rotatable by the turbomachine, the fan comprising a plurality of fan blades;
a plurality of outlet guide vanes located downstream of the plurality of fan blades of the fan;
a casing surrounding the plurality of fan blades or surrounding at least in part the turbomachine, the casing defining an opening at a location upstream of the plurality of outlet guide vanes; and
a compressed airflow injection assembly positioned at least partially within the casing and including a controller configured to open and close a valve at a specified blade passing frequency using pulse width modulation control to provide a flow of compressed airflow through the opening in a repeating pattern based on the specified blade passing frequency during an operating condition of the gas turbine engine.

2. The gas turbine engine of claim 1, wherein the casing is an outer nacelle surrounding at least in part the plurality of fan blades.

3. The gas turbine engine of claim 1, wherein the opening in the casing is located downstream of the plurality of fan blades and upstream of the plurality of outlet guide vanes.

4. The gas turbine engine of claim 1, wherein when the gas turbine engine is operated in the operating condition, the plurality of fan blades define the blade passing frequency, and wherein the compressed airflow injection assembly is configured to provide the compressed airflow through the opening as a pulsed airflow defining a pulse rate equal to the blade passing frequency when the gas turbine engine is operated in the operating condition.

5. The gas turbine engine of claim 4, wherein the compressed airflow injection assembly is configured to provide the flow of compressed airflow through the opening as the pulsed airflow at the blade passing frequency out of phase with the plurality of fan blades.

6. The gas turbine engine of claim 1, wherein the compressed airflow injection assembly comprises an air tube extending between an inlet and an outlet, wherein the outlet is in airflow communication with the opening.

7. The gas turbine engine of claim 6, wherein the valve is a solenoid valve in airflow communication with the air tube and configured to pulse the flow of compressed airflow through the air tube.

8. The gas turbine engine of claim 6, wherein the inlet of the air tube is in airflow communication with a high pressure air source.

9. The gas turbine engine of claim 8, wherein the turbomachine comprises a compressor section having a compressor, and wherein the high pressure air source is the compressor of the compressor section of the turbomachine.

10. The gas turbine engine of claim 1, wherein the opening is a first opening of a plurality of openings defined by the casing, and wherein the plurality of openings are spaced along a circumferential direction of the gas turbine engine.

11. The gas turbine engine of claim 10, wherein the plurality of openings defined by the casing includes a number of openings equal to N1, wherein the plurality of outlet guide vanes includes a number of outlet guide vanes equal to N2, and wherein the number, N1, of the openings is equal to or greater than the number, N2, of outlet guide vanes.

12. The gas turbine engine of claim 1, wherein the gas turbine engine defines a cross-sectional plane relative to the axial direction, wherein the compressed airflow injection assembly is configured to provide the flow of compressed airflow through the opening at an angle greater than 0 degrees and less than 75 degrees with the cross-sectional plane of the gas turbine engine.

13. The gas turbine engine of claim 1, wherein the compressed airflow injection assembly is configured to provide the flow of compressed airflow through the opening at an angle greater than 0 degrees and less than 45 degrees in a circumferential direction of the gas turbine engine and in a rotational direction of the plurality of fan blades.

14. The gas turbine engine of claim 1, wherein the compressed airflow injection assembly is configured to provide the flow of compressed airflow through the opening at an angle greater than 0 degrees and less than 30 degrees in a circumferential direction of the gas turbine engine and against a rotational direction of the plurality of fan blades.

15. The gas turbine engine of claim 1, wherein the compressed airflow injection assembly reduces noise caused by an airflow from the plurality of fan blades during the operating condition of the gas turbine engine by distributing vortical structures generated by the airflow from the plurality of fan blades along a radial direction of the gas turbine engine with the compressed airflow.

16. A method of operating a compressed airflow injection assembly for a gas turbine engine, the gas turbine engine comprising a turbomachine, a fan having a plurality of fan blades, a plurality of outlet guide vanes, and a casing surrounding the plurality of fan blades or enclosing at least in part the turbomachine, the method comprising:
providing a compressed airflow through an opening defined in the casing to a location upstream of the plurality of outlet guide vanes, wherein providing the compressed airflow through the opening comprises actuating a valve to open and close at a specified blade passing frequency using pulse width modulation control to provide the compressed airflow through the opening in a repeating pattern based on the specified blade passing frequency.

17. The method of claim 16, wherein the casing is an outer nacelle surrounding at least in part the plurality of fan blades.

18. The method of claim 16, wherein the opening in the casing is located downstream of the plurality of fan blades and upstream of the plurality of outlet guide vanes.

19. The method of claim 16, further comprising:
operating the gas turbine engine such that the plurality of fan blades define the blade passing frequency;
wherein providing the compressed airflow through the opening in the repeating pattern comprises providing the compressed airflow through the opening as a pulsed airflow defining a pulse rate equal to the blade passing frequency.

20. The method of claim 19, wherein providing the compressed airflow through the opening as the pulsed airflow defining the pulse rate equal to the blade passing frequency comprises providing the compressed airflow through the opening as the pulsed airflow out of phase with the plurality of fan blades.
